(19) United States
(12) Patent Application Publication
(10) Pub. No.: US 2008/0183504 A1
(43) Pub. Date: Jul. 31, 2008

(54) POINT-OF-CARE INFORMATION ENTRY

(75) Inventor: Robert D. Highley, Kirkland, WA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Robert D. Highley, Kirkland, WA (US)

(21) Appl. No.: 12/060,034

(22) Filed: Mar. 31, 2008

Related U.S. Application Data
(63) Continuation of application No. 11/522,093, filed on Sep. 14, 2006.

(51) Int. Cl. G06Q 50/00; G06Q 99/00; G06Q 30/00

(52) U.S. Cl. 705/3; 705/1; 705/34

(57) ABSTRACT

A point-of-care touch/click entry system can be used to replace and/or augment standard dictation transcription models in medical record systems (which comprise institution-centric data). Key word entry can better standardized medical record display, can be linked directly to diagnostic and billing codes to automate billing thus decreasing payers claims of fraud and can be used to insert data variables directly into relational databases to improve outcome analysis. In total the “clinical operating system (COS) and clinical information system (CIS) can quickly and accurately produce “longitudinal” lifetime medical records (which comprise patient-centric data). The longitudinal medical record can be used in accordance with medical record systems to connect patients, providers, pharmacies, clinics, hospitals, payers, and producers through a secure private network that operates in real-time at the point of care on-line or off-line.

### RELATED APPLICATION

### Priority Claim

This application is a continuation-in-part of U.S. application Ser. No. 11/522,093 filed on Sep. 14, 2006, which is hereby incorporated by reference. This application claims the benefit of the disclosure made in that application and its filing date under 35 U.S.C. § 120.

### BACKGROUND

The present medical record system is institutionally based. Medical records are often stored as “charts,” and are typically owned and maintained in accordance with the needs of the healthcare institution that uses the records. The history and physical sections of the charts are virtually infinitely variable. Because of the potential for infinite variations, charts do not allow for standardization or template construction. Histories and physicals for charts are typically dictated in a free text form such that specific historical or physical examination variables are not readily accessible for database analysis, for clinical research for outcome analyses. When clinical studies are conducted using charts, the charts are “pulled” and the variables are extracted by hand and entered into relational databases for statistical analysis.

In contrast, diagnoses and procedures are relatively standardized and are normally coded using ICD9 coding systems for diagnoses and CPT coding for procedures. The coding systems were originally developed for billing system purposes. Because physicians often get paid more for one diagnosis as compared to another; there tends to be a “diagnostic creep” toward higher billable diagnoses and higher paid procedures. Thus, conventional coding systems tend to generalize and/or group diagnoses according to billing requirements and do not usually precisely indicate a more exact diagnosis that would be better suited to outcome analysis.

### SUMMARY OF THE INVENTION

The present disclosure provides exemplary embodiments of the invention, which is defined by the claims as recited herein. In various embodiments a point-of-care automated touch entry dictation system can be used to replace and/or augment standard dictation transcription models in various electronic medical record systems. The prior art records are typically non-standardized, institution-centric data. The above referenced patent (Ser. No. 11/522,093) described a Clinical Operating System (COS) whereby disparate medical records could be connected through a smart card security system to create a “longitudinal” medical record system where medical encounters are collected into one medical record over time and across delivery systems. (This is patient-centric data, meaning the patient owns the record, controls the access and supervises its content). Longitudinal medical records can be used in accordance with existing medical record systems to connect patients, providers, pharmacies, clinics, hospitals, payers, and producers through a secure private network that operates in real-time.

The point of this patent application is to describe a unique point-of-care touch entry dictation system (TEDS) that will enhance integration of our COS (Clinical Operating System) with a fully integrated CIS (Clinical Information System). The TED system collects previously uncollectible variables, using a standardized “key word” tag and then allows the clinician to wrap any sentence structure of their choosing around that “key word tag”. This allows “variable standardization”. Variable standardization is an oxymoron with two meanings. 1. The variables are collected and standardized into a relational database as they are selected/touched and 2. There is a huge variation in how that one variable can be displayed so that it reflects the style of the user and is unique to the clinician. The TED system also incorporates a proprietary coding system for otherwise un-coded historical and physical variables that is designed for research purposes such as data mining and outcome analysis. So instead of storing huge paragraphs of descriptive data (multiple kilobytes) the key element can be coded in a 5 digit number that can be more easily stored on the COS portable record system. In addition, our automated coding scheme is designed to enhance but not replace the current ICD9 codes to more accurately reflect the patient's true diagnosis and yet not disrupt the conventional prior art billing system. Having truly uniform diagnoses will allow the comparison of “apples to apples” rather than the present “apples to oranges” comparisons that taint outcome analysis. The intent is to store more data, more compactly, and more accurately so as to improve outcome analysis but not alter present billing systems that would be too difficult to replace in the near term. Having these outcome results available for research purposes would improve the extrapolation of clinical trials into clinical practice by using these often neglected co-variables to target subpopulations that would or would not benefit from therapies determined by randomized controlled trials (RCT). In this manner, ALL of the patients' demographic, historical, financial and clinical information and the health-care providers' physical examination observations and diagnostic testing are collected for both outcome analysis and billing purposes, as well as making a diagnosis.

The previously described portable medical record COS (patent application Ser. No. 11/522,093) combined with a fully integrated CIS using the presently described TEDS application for storage allows on- and off-line data retrieval for automated and accurate outcome analysis. The disclosed system can be, for example: 1. Patient centric, 2. Ultra-secure & HIPAA compliant, 3. Longitudinal (single lifetime record over time and across delivery systems) 4. Global (available anytime, anywhere the world), 5. Standardized, 6. Automated (dictation, billing, and relational database inputting), 7. Available both on- and off-line (day to day and in emergencies), and 8. With or without power of the Internet (disaster preparedness).

### BRIEF DESCRIPTION OF THE DRAWINGS

Non-limiting and non-exhaustive embodiments are described with reference to the following drawings.

FIG. 1 is a logic diagram illustrating a security system for medical records.

FIG. 2 is a flow diagram illustrating a Touch Entry Dictation System.

FIG. 3 is a flow diagram illustrating automation of constructing a medical record

### DETAILED DESCRIPTION

Various embodiments will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. The meaning of “in” may include “in” and “on.” The term “coupled” can mean a direct connection between items, an indirect connection through one or more intermediaries, or communication between items in a manner that may not constitute a connection.

The point-of-care touch entry dictation system (TEDS) can be used with (and/or as part of) a medical record system to provide technology solutions and business processes that can connect authorized parties in real-time, with connectivity such as provided by the Internet, on or off-line should power or the internet be disrupted (patent application Ser. No. 11/522,093). This has disaster preparedness implications since the records would be available in disaster like hurricane Katrina where all other web based systems would fail. A global portable medical record system (GPMR) can provide universal connectivity with or without the Internet to concerned parties at arbitrary locations.

In an embodiment, a smart card provides a portable medium to carry medical emergency data on the card and provides “ironclad” security access to a virtual private network (VPN) or Private Network (PN). The VPN or PN provides secure encrypted data transmission among the “six P's” (Patients, Providers, Payers, Plans, Pharmacies and Producers). The VPN cannot be entered without a smart card issued by a certificate of authority. All exchanges of information can be tracked to insure patient privacy and HIPAA compliance. An ASP (application service provider) model can be used to deliver the contents of the medical record and connect the smart card records to the VPN and database servers to complete the system.

The portable medical record system acts as an clinical operating system (COS) to connect disparate CIS to provide a longitudinal record of original data over time and across delivery systems. In operation, each institution records the current episode of care and adds that original data to an ongoing longitudinal record. The patient carries a smart card with core data for emergency use and a link (such as a URL) to the server where each of their medical records is housed. In this way, universal access is provided to an ultra secure, fully integrated, real-time, portable medical record that aggregates original data over time and across delivery systems. Integration and connectivity should decrease medical errors, improve care and reduce costs. Additionally the smart cards can be configured to download pertinent information such as demographic information to any form, registration or note within the ASP framework.

Global Portable Medical Record (GPMR) refers to a smart card microchip record that can contain, for example, more than 30 pages of core data (demographic data, contact information, allergies, insurance information, growth and development, social history, family history, list of medications, problem list, implantable devices, security preferences, HIPAA preferences, living will, birth certificate, and the like) that can be read directly from the card (when, for example the core medical record can only be accessed off-line.) When WAN or Internet connectivity can be established (e.g., when the core medical record is on-line), a locator such as a URL code stored in the card can direct the user to the server where each part of the complete medical record is stored. (Thus, the GPMR provides limited off-line access to core medical data stored on the card in any emergency with or without power or the Internet [OFF-line]. A URL link provides real-time on-line medical records so concerned individuals can be connected through a secure network [On-line].) The portable record acts as an operating system to connect disparate CIS in real time and we refer to the connectivity function of the portable record as COS the Clinical Operating System.

Web record refers to the complete medical record (labs, X-rays, procedure notes, etc) stored on a server managed by a Clinical Information System (CIS) and accessed over the Internet, for example.

Clinical Information System (CIS) is a software application that enters, records, stores and retrieves medical records from a database repository. Well known systems are HBOC, OASIS, EPIC, Cemer, IDX/GE, PHAMIS, Last Word, and the like.

HIPAA-Health Information Privacy & Accountability Act is a set of Federal regulations that mandate limitations to health records and rules governing access to private medical records. The legislation indicates that the medical record belongs to the patient and access to their personal record can only be achieved with the permission and direction of the patient or their designated guardian. Thus the individual owns and controls the use of their personal record.

Dual Access Security (DAS) refers to a method for security access to medical records. To access a portable medical record requires (at least) two keys and two passwords to enter either the portable medical record or the web record. Accordingly, the patient normally needs to have physical possession of their GPMR (which contains at least one first key). The patient inserts (physically and/or logically) the GPMR (which is typically in the form of a CPU card such as a smart card) into a reader that has been issued and authenticated by the private network and gives permission to access the record by entering one of two pre-determined passwords (for example, one password for the regular record and a second password for information the patient has pre-selected as being sensitive to them). When the patient has been authenticated and permission granted, the patient will typically withdraw the card. (A password as used herein can also refer to biometric identification unless the context clearly means otherwise.)

The role-based security system can be used for other applications on the same card. The memory on the card can be partitioned into sectors such that a particular sector can only be accessed by a certified provider card issued by a certificate of authority. For example, if a policeman inserted his card into the system and then accessed the patient card, he would only see a driver's license. If a passport agent inserted her card, she would only see a passport. An election judge would only have access to a voter's ID, whereas a doctor would see the medical record. In various embodiments core insurance information would be placed on the card, including a URL for the insurer's server for providing real-time point of service insurance adjudication (with or without the usual “clearinghouse” mechanism).

A second key and password are needed to allow a provider to gain access to the system/VPN (or PN). The provider (such as a physician) inserts their microchip identity card issued and authenticated by the network. A biometric marker such as a fingerprint may be requested as well. If the card's security number(s) and biometrics match the user ID and password pre-validated within the system, then the card is authenticated and access to the patient's record will be allowed, if the patient gives consent. (The provider activates the system first so the patient can use their card to give consent). The patient's identifier can be a larger-than-9-digit number preceded by a 4 to 8 digit insurance code. The physician's identifier can also be a larger-than-9-digit number preceded by a number (or other identifier) of the delivery system in which the physician is privileged. The physician may have several such identifiers on the physician provider card. If the insurance codes match, the physician has implicit permission to enter, modify, or delete information from the record stored on the patient medical record. If the codes do not match, then the patient's password must be given as consent to release medical information. In various embodiments, bio-metric markers (such as fingerprint, voice, retinal scan, and the like) can be used. If the biometric markers, the passwords and/or other pre-installed security codes match, the record can then be accessed.

Additional conditions can be placed on the transaction. For example, security levels can be selected by the patients which joining the system such that only parts of the record can be accessed (such as open access, a regular record or a sensitive record). Also, only that patient's record can be accessed. (In conventional web-based systems, it may be possible to gain access to all of the records on an accessible server. In a smart card system normally only the record that passed all of the security requirements can be accessed.) When the physician withdraws the provider card, the session automatically ends without a cache to return to that record (which is present in many conventional web based systems). This provides additional security, guards the patient's privacy and protects the physician from, for example, JACHO fines if they fail to log off the system and leave sensitive patient information on the computer for passersby to see in violation of the HIPAA mandates.

Functional Interoperability Field-to-field standardization among delivery systems or Clinical Information Systems has been difficult to achieve because competing proprietary systems prefer standardization only if they are the standard. Haggling about standards has made field to field interoperability nearly impossible to achieve. DAS can resolve this problem. Delivery systems only have to agree to use the same security protocol to access their proprietary CIS. Provider smart cards can be used to log on to disparate Clinical Information Systems from afar. The clinical data can be accessed, wherever the patient's data resides and independent of the information system. The global portable medical record belongs to the patient (as compared to the institution) and when the patient gives permission only that patient's record for that session at that time can be pulled up and accessed on that CIS. This can substantially reduce partisan bickering over field structures that has impaired medical record exchange since the 1980's, and allows records to be shared in any CIS in a read-only format to provide a level of functional interoperability.

Functional Interoperability features provide a functional solution to data sharing at the point of care without having to come to universal agreement on all interoperability standards. A privileged provider (having a verified identity, being credentialed by a delivery system, and authenticated by the private network as a legitimate up-to-date valid subscriber) can access the server where the patient's full web record is stored to access needed information. For example, the privileged provider can read from a record in Illinois and write orders in their own CIS in Oregon. A summary can be sent to the attending physician back home in Illinois and that can be scanned into the system in Illinois. Records can thus be shared across delivery systems in real-time providing continuity of care such that functional interoperability (a shared medical record system) is achieved.

### Medical Record System

Prior Art—Accessing information stored using conventional medical record systems (which are often implemented using paper or more recently electronic “charts”) is often problematic when conducting “outcomes research.” The data is not available in a relational database format but is usually available retrospectively by examining the records by hand and extracting pertinent data for previously dictated free text and entering that data of interest into a relational database. Laboratory data however is usually available in a relational database format because it is more standard (name of test & value of test). Doing retrospective chart review is costly and it is limited because only certain preordained variables are analyzed and the data can only show association and not causation, which requires prospective data collection preferably randomized. We will show that collecting variables and co-variables from routine care can be used to target therapy and target populations, which can markedly reduce health care costs by double digit percentages.

Another problem with conventional systems is that patients typically do not have full ownership rights (access to and content control of) the actual physical charts that are stored in various health provider locations. The patients' histories can be fragmented as the result of, for example, dozens of encounters with hundreds of health providers. The encounters with various providers normally result in records being generated and kept across many delivery systems for various (and often lengthy) periods of time. (This problem can be reduced by using a portable medical record device that the patient owns and can physically transport to access various delivery systems at various times as discussed in the parent application U.S. application Ser. No. 11/522,093 filed on Sep. 14, 2006.)

When the fragmented histories are gathered, discrepancies are noted, and if one version is mistakenly chosen over the other, errors can be made. Sorting out the fragmented data leads to redundant testing, additional cost and often more confusion. Because records are not available in real time, the notes are not usually available when they are needed most in an emergency situation. Even when the record is dictated on admission it may be transcribed off premise and take a day or more before it is available to the doctor that dictated it. In the case of outcome analysis the record is reviewed well after the fact but even then the history and physical data is not readily available for analysis and the data has to be “pulled from the record” by hand and entered in to a relational database for computer analysis. Furthermore, there is no coding system for most of the history and physical variables and co-variables, which can be used to determine a diagnosis, to define the severity of disease, and to predict outcomes. Conventional coding systems (such as ICD9 and CPT codes) were designed primarily for billing purposes. Because payment is based on coding, there can be a “diagnostic creep” to justify higher fees. The diagnostic creep can distort analyses of outcomes when using billing codes to identify illnesses.

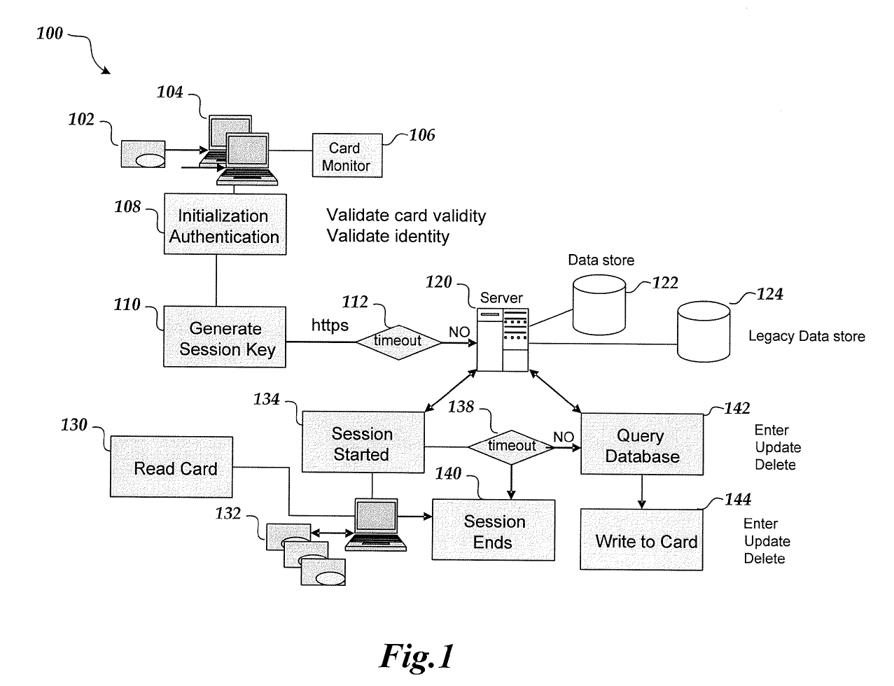

FIG. 1 is a logic diagram illustrating a dual access security system for medical records. System 100 comprises a smart card (which is a microchip card/CPU card or could be, for example, a memory card with or without processing capability). The smart cards can be a provider's card 102 and/or a patient's card 132. Patients would be issued smart card medical records 132 by their insurance company or by Medicare/Medicaid or a public health agency or other issuer. The issuer would normally provide identity data to guarantee the identity of the card holder.

Patients can use their card to gain access to system 100. At the first contact new subscribers would typically be asked a series of questions to complete their medical record (demographic, contact, and insurance information, allergies, problem list, past procedures & surgeries, devices, legal documents, living will, code status, growth and development, disabilities, vaccinations, list of medications, etc). The entry page can be web-based and filled out at home or at a kiosk (at the doctor's office, Public Health Service, library, and the like) that is connected to the system 100. A URL embedded within the card can be used to find the server, where the data are stored. That data can be linked to a mirror server for back up and to aggregate all of the data for outcome analysis. The Internet data transfer can be done through a Private Network accessed by a smart card that has been authenticated in the system, which increase the security and hence the privacy of the system. If the public Internet is used then the transfer would normally be encrypted (by using a secure socket layer, for example) to ensure patient privacy, as discussed below.

The cards 132 function as portable medical records carrying core medical, legal, financial, insurance, and identity data (such as a passport or driver's license or a voter's ID, and the like). The insurance policy benefits can be stored on the card and used to adjudicate insurance directly from the card at the point of care. Pre-paid “money” stored on the cards can be used for co-payments or deductibles. A magnetic strip can be applied to the card, which thus can be used as a credit card to pay for co-payments and deductibles. Real access to the patient's data requires the physical possession of an authenticated patient card 132 and a matching valid password from the patient. It also requires the physical possession of a valid provider card 102 and authenticated by a biometric marker (such as a fingerprint, voice, retinal scan) and/or password stored in the system and encrypted on the card.

There can be, for example, three levels of security determined by individual preference stored on the card: open access, regular record access, and sensitive information access. When the card is inserted into a reader, open access is available to the extent allowed by the patient. If the patient wants to protect sensitive information they will give the standard password and if they want the doctor to know about the sensitive information they can type in their second password allowing access to this data. This gives added HIPAA protection for the patient and the patient controls both access and content as originally intended by Congress.

The smart card readers at stations 104 and 136 perform a security check to guarantee the card's authenticity. The network can sort out counterfeits using authentication procedures. The database (data store 122 and/or legacy data store 124) is the data authority and when accessed on-line downloads the most recent changes to the smart card portable record. The information can be synchronized to update the cards or update the database. If the card is lost or stolen it can be re-issued from the database repository.

The data on the cards 132 can normally only be accessed by a “provider smart card” 102 issued by the system 100. So if a patient card is lost the only information available to a lay reader would be what was designated as open access (name, phone number, and address, for example) to return the card. If the patient prefers, the entire record can be made available as open access (in case, for example, the patient is unconscious or unable to give a password he/she can pre-authorize access and treatment preferences while they are competent to make decisions.).

Providers (such as RNs, MDs, pharmacists, and the like) can be issued a card by the delivery system where they work. The credentials of the card holder would be validated by the delivery system to guarantee the identity of and privileges for the cardholder. The delivery system can credential each provider with the state board of medical examiners each year and the provider cards can facilitate the annual renewals.

Provider cards can be used to access disparate Clinical Information Systems (CIS) if they are connected to the private Network and have password permission from the patient. For example, if a Mr. Stewart, a patient of a Dr. Jones at the University of Washington gets sick while traveling in New York, a Dr. Peck at Cornell can get access to Mr. Stewart's electronic record back in Seattle by having the patient insert his card 132 and type in a password. If Cornell and U.W. are subscribers to the GPMR Private Network, then Dr. Peck can read the record stored in a Cerner-CIS (a first proprietary system) in Seattle even though he regularly uses a HBOC-CIS (a second proprietary system) at Cornell. This provides functional connectivity but not true field to field interoperability. This eliminates the need for field to field interoperability standards and allows different CIS systems to effectively communicate with each other by only sharing security access. This protects proprietary CIS systems, while promoting universal access.

Server 120 provides a Clinical Operating System (COS) that can connect various stations to a common integrated record that operates in real-time. The Touch Entry integrated CIS (Clinical Information System) would provide true field-to-field interoperability, since the field structure would be the same for each delivery system that used it. The COS system can create a process for a “longitudinal record” where each original episode of care is appended over time and across delivery systems into a single longitudinal medical record. In a longitudinal record system “reconstruction” is not necessary, since all of the original episodes of care are available. Fragmented care is avoided and continuity is promoted so that systematic medical errors can largely be avoided. For example, adverse drug interactions are the fifth leading killer in the United States, and the surest way to prevent them is to have all concerned parties connected to the same pharmacy computer system and have that system operate in real-time.

The proposed TEDS (Touch Entry Dictation System) linked to integrated CIS software can automatically collect data from the usual care processes and automatically enter the collected data into a relational database for analyzing the outcomes from the natural variations in care among practitioners. The knowledge base generated from collecting this variation can be used to optimize care for the entire population. The outcome analysis can be used to create evidence-based protocols to then decrease the variation in care standardizing to the best outcomes. This process can reduce medical errors, optimize healthcare outcomes, save lives and substantially decrease the cost of healthcare.

In operation, system 100 in various embodiments permits authorized access to medical records stored via server 120. When a provider card 102 is inserted into a station 104 and authenticated (108), a session key is generated (110) by the card and sent to server 120 along with the cardholder's name, ID number, and access level. The server initializes a new session (134) and stores (122 and 124) this information for future use. This session information is retained even after the provider card is removed (106). Depending on the application, when the provider card is removed the application will either return to the login page or display an Insert Patient Card prompt. The session remains active as long as the patient's card is in the reader until (at 140): the user logs out of station 136; the card timeout period of 15 minutes (for example) elapses (112); the server session timeout period (138) elapses; or the card is removed for the reader.

After a provider card 102 has been authenticated and removed, a patient card 132 can be inserted into station 136 and read (130). A provider's access level determines what information on the patient card 132 can be viewed. If the patient is a subscriber to the same insurance group to which the provider belongs, no additional consent (for example) is required for the provider to view (142) and modify (144) information. If the provider does not belong to the same insurance or delivery system group, then the patient can be required to enter their password, which acts as an electronic signature and provides legal consent to release medical information. To view information that the patient has tagged as sensitive, the patient would enter their second password to give consent to access that information.

When the patient card 132 is removed, the patient record is closed, the application returns to the login page, and previously viewed pages are removed from the cache. The original provider session can remain active and a different patient card may be inserted and viewed without having to authenticate the provider card again.

In various embodiments, the dual access security system allows the smart cards to look and function differently depending on the issued authority of the provider card. The patient/consumer card can be partitioned to include, for example, a driver's license or passport or voter's ID, credit card, as well as a medical record. The important premise is that data can be stored directly on the card and a URL can connect the user to a much larger associated database.

In an example, a provider could be a police officer. When the police officer inserts the officer's provider card, the officer can be authorized access only to the driver's license partition on the card, and the officer would only see a driver's license. An associated URL on the card could allow the officer to access a server run by the state to check for outstanding warrants, parking tickets, parole violations, etc.

If the patient/citizen were to go to Canada and insert their smart card at emigration, the officer there would see the partition dedicated to passport data and a displayed URL could be linked to a homeland security database. The cards can provide real ID, which would help sort names on the no fly database into the real offenders from people with the same name. Because the cards can be used to uniquely identify (and/or authenticate access) individuals on the Internet, the cards could be used for Internet voting. The cards can be used for POS (Point Of Service) insurance adjudication. The cards can also be linked to credit card service providers (such as American Express, MasterCard, and VISA) to function as more robust secure credit cards, which reduces the possibility of identity theft. These are a few examples of the embodiments for the dual access security system.

### Insurance Adjudication

Health insurance plans are proprietary and non-uniform. Individual insurers sell health insurance providing coverage over a variable period of time that may range from weeks up to a year. Each insurance plan typically has different coverage for different services: for example, one plan may cover 100 percent of the cost of drug X but only 80 percent of drug Y (having a formulary preference), a second plan may have a 20 percent prescription deductible cost, while a third plan may have a set cost of $15 per prescription. Because of the huge variability and the large amount of “fine print”, patients normally have considerable difficulty keeping track of their coverage (hospitals clinics and druggists also expend much effort trying to do the same). It is estimated that more than 70 percent of the phone calls directed to an insurer are to establish coverage. Common questions are: Am I still covered? What is the name of the plan? What are the features of that plan? Can I get this and what will it cost me?

Because of the complexities, third parties are used to clear the data. The use of third parties is inefficient and time-consuming, leading to delays that adversely affect the quality of care for patients. For example, Insurance clearinghouses are used to establish the coverage for a particular patient. For example, if a patient goes to a hospital emergency room, the patient normally is required to register. The registration process establishes the patient's identification, their contact information and their ability to pay for the service through an insurance carrier. The registration clerk typically expends time to call the clearinghouse to see if that patient is still covered (“paid up”) and to determine the plan type, what is covered, and what deductible needs to be collected for the hospital/ER to cover their costs. The clerk typically has to find if pre-authorization is required and what number has to be called to verify the pre-authorization. As described above, such inefficiencies can lead to excessive costs and potential harm.

Patient registration using third party clearinghouses typically takes from around 15 to 20 minutes and for life threatening conditions (such as sepsis, stroke, myocardial infarction, and the like): the extra 20 minutes can cost the patient their life. This process of checking on the payment before checking on the patient can lead to the patient viewing the hospital as a heartless business more interested in money than the patient at this critical time. The tradeoffs between rapid care and cost recovery can foster resentment in the patient and provide additional motivation for filing a malpractice claim if anything goes wrong during the stay.

### Smart Card Solution to Insurance Adjudication

In accordance with the present disclosure of a dual access smart card based portable medical record, insurance clearinghouses can be “by-passed” by having insurance companies issue the smart card records as their insurance cards. The patient's portable record/insurance card, would contain (for example) information regarding the patient's identity, the insurance companies contact information, the plan type and deductibles that need to be collected during this hospitalization and the duration of coverage. Because the information is on the card, it is available at the point of care where ever that may be. The duration of coverage can be obtained in real time by using the URL on the card to link to the insurance's company's web site where a database resides that has a listing of all of the patients in Insurance company X's Plan Z and when their coverage expires. If the treatment date is less than the expiration date the patient is covered. There can be an extensive listing of coverage features, co-payments, deductibles, formulary preferences associated with this plan from the insurers' database.

Thus it would no longer be necessary to question the patient each and every time the patient accesses a provider; because the insurance card itself can download all the information required for registration in a matter of seconds. The smart card than can go to the Internet and determine whether the patient's insurance policy is current. If the patient ever changes insurance, a new patient card would be issued (by the new insurance company) and the existing clinical data stored in the server could be transferred to the new insurance card and the new insurance policy would be accessed by the URL of the new insurance company on the new card. This makes registration quicker, and the payment issues are automated, allowing for faster treatment times, better patient care, less resentment and potentially less malpractice claims.

The medical record system in accordance with the present disclosure can disseminate insurance data more universally. For example, a small pharmacy may only need access to a patient's drug coverage information. A small store would be able to implement a real time state-of-the-art insurance adjudication system fairly inexpensively by using a card reader ($25) attached to their computer or PDA, a provider card ($50) and an Internet address provided by an ISP ($30). Their ROI (return on investment) could be less than two days, because the pharmacy worker would not have to manually access paper or make multiple phone calls to obtain the desired information. This would save them about 5 to 20 minutes per prescription.

The card-to-database technology is used to efficiently provide insurance adjudication at the point of service be it a pharmacy, a clinic, a hospital, the ER or when the medics come to your house in an emergency. The cards provide the functionality of conventional insurance cards issued by an insurance company, but also can include fields for secondary insurance coverage, because they might have additional coverage through their spouse or guardian. Accordingly, each insurer's name, plan type and core coverage data (at least) is on the card.

The insurance company can optionally continue to use clearinghouses (by providing a URL for a clearinghouse on the card) or the insurance company could reduce the costs associated with using a clearinghouse by providing URLs for the insurer servers that contain the data. The insurer's database would typically include information such as a current list of what services a particular insurance plan covers, any formulary restrictions for the particular plan, a list of customers and associated coverage dates for the particular plan. Thus, when an authorized provider presents valid patient credentials, the plan information and coverage dates for that specific consumer's insurance ID number can be used to update that data on the card so it is as current as the last download.

Other benefits of this adjudication system include: 1. Reducing the possibility of inputting errors causing incorrect billing or clinical information; because the card downloads the ID numbers directly from the card and the clerks don't have retype in the names or numbers into the hospital's registration software. This removes human error from the ID data exchange. 2. Eliminating fraudulent use of a plastic insurance card; because the micro-chip smartcards have photo IDs, physical descriptors and unique passwords that guarantee the identity of the cardholder. This is good for the patient, the hospital and the insurance company.

### Point-of-Care Touch Entry Dictation System (TEDS)

A point-of-care touch entry dictation system/TEDS can be used in the disclosed medical record system to reduce dictation requirements and to input information directly into a relational database. Dictation for a 30-minute medical visit typically takes anywhere from four to seven minutes for a health care provider. Transcribing the medical dictation usually requires knowledge of a highly specialized language that has an extended vocabulary of about 300,000 words. Doctors often dictate extraordinarily fast, which often results in transcription errors.

For example, the dictation “The patient has known coronary artery disease” has been transcribed as “The patient has no coronary artery disease.” If such errors are not caught and corrected it could cause a significant alteration in therapy and subsequent errors which could be fatal to the patient. (Other errors can be merely comical: the dictation “The patient is circumcised” has been transcribed as “The patient is circus sized.”)

Transcriptions often take days to weeks to be returned to the author, even in electronic record systems. If the authoring physician dictates on Monday and the patient returns on Tuesday with continuation of a problem, it is often difficult to remember what was said or done. The physician can look foolish and/or the patient can be mistreated based on a faulty memory of the yet-to-be transcribed events. When the record finally is returned, it may be used to document any malpractice after the fact. Such problems can be reduced if the records are made available to the healthcare provider in real-time as they construct the record.

The reliability of patient interviews typically vary with the amount of time the physician spends with the patient, the physician's past training and expertise, and the storytelling ability of the patient. These factors can facilitate the creation of errors while inputting data into the record.

Moreover, physicians are often faced with having to dictate a note (entry) for a medical encounter and later having to remember exactly what they said and did with multiple intervening interruptions. Minutes to hours after the dictation, the physicians usually have to fill out a coding document for billing that encounter. The coding scheme and related federal and state laws are too many and too complicated to fully understand for the average physician (who would typically like to concentrate on the patients, rather than on billing). A recent survey has estimated that the coding is done correctly less than 70% of the time. Incorrect coding often has potential undesirable consequences for both the physician and patient (for example, there are potential criminal penalties for defrauding Medicare). Each office typically hires specially trained coders to help with coding, billing, education, and auditing.

A point-of-care entry system can include a “touch entry” (and/or “voice entry,” as described throughout). This dictation system can be used to improve upon the conventional methods of recording physician/provider notes. For example, when constructing a History & Physical (“H&P”) note the physician/provider usually gathers a patient's verbal complaints and other historical information and organize these in accordance with a time-tested convention that every medical student is taught. The convention/organization typically comprises a “chief” complaint, which is followed by the patient's history of present illness, the past history, the review of systems, the social history, the family history, the physical examination, problem list, then the diagnostic assessment and a disposition/plan of action.

Various subsets of notes from this global organization include consultation notes, procedural notes, follow-up notes, surgical notes, encounter notes, and the like. These same notes usually are given different titles for billing purposes. For example, the same structured H&P note may be called a New Patient Note or a Consult Note depending on the intent of follow up. A new patient will be followed by the specialist whereas a consultation normally only include one or two return visits before the patient returns to the referring physician.

Generating codes for proper billing can be even more difficult because of many exceptions to the rules and the fact that the doctor normally generates a bill based on retrospective evaluation based on a personal recollection of what they just dictated (in contrast with an evaluation by typically parsimonious reviewers who usually have a formatted check list in front of them). The conventional coding/billing system has generated accusations of fraud, heavy fines and threatened imprisonment to well-intentioned physicians because of its complexity and other structural impediments.

The touch entry dictation system is typically a multifunctional software-based system that quantitates, organizes and records the patient's historical information and the provider's physical examination observations in real-time in a standardized format one variable at a time. The system is used for linking that information both to a relational database for outcome analysis and transferring the information to a billing system for uniform and more accurate billing based on the total of recorded information. For example, the system can be used to record a standardized medical history and physical examination of patients using keyword entry to produce varying narrative text. The system also comprises a coding system using variables for sorting and searching within a relational database. The system can be used to automatically link these entries into a uniform billing system that meets required standards.

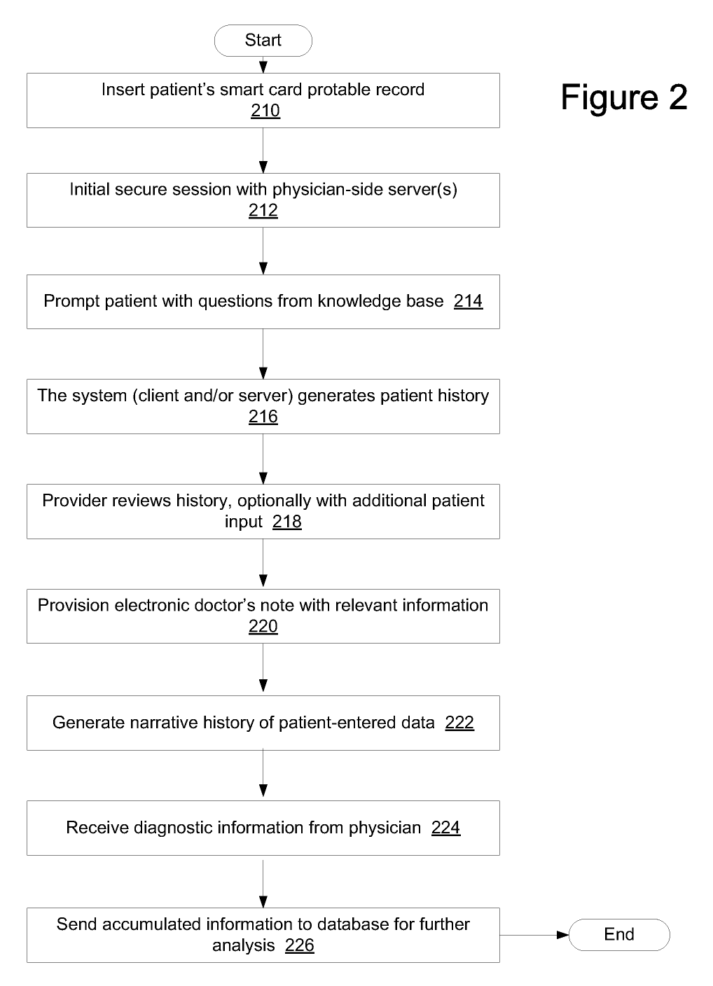

FIG. 2 is a flow diagram illustrating a Touch Entry Dictation System. A Touch Entry Dictation System (TEDS) is a point-of-care entry system that can be used to construct longitudinal patient records. The Touch Entry Dictation System allows real-time data entry by the patient, the nurse, and the physician in a standardized manner.

In operation 210 of the Figure, a patient typically uses an entry terminal (such as a kiosk) in a physician's office to insert the patient's smart card portable record. The entry terminal system can use a password (and/or biometric identification) to authenticate the identity of the patient.

In operation 212, the smart card initiates a secure session with the physician-side servers. After the patient is authenticated at a desired level, a session can be conducted in accordance with the level of authentication established. The session can be used to retrieve the patient's previous history from the servers, synchronize the medical histories between the server and the card, and to verify through the server what services are to be provided to the patient. For example, the server record can determine if the patient has a present or an upcoming, or a missed appointment.

The system typically retrieves: demographic data, insurance information, medical problem list, list of medications, vaccinations, etc and looks up the reason for their visit and who referred them. The information can be used to “feed” input information to an expert system (such as a knowledge base/engine) so that more medically appropriate questions can be asked (and provided to the health provider).

In operation 214, the herein described system asks the patient a series of core questions. The core questions are asked by an expert system that has been implemented using a knowledge base of health examination questions. In response to particular answers from the core questions, more detailed questions can be asked until, for example, the system exhausts its questions and/or reaches a likely diagnosis. Each response by the patient can usually be given using a click or touch entry (for a yes/no response, for example) or a typed-in value when more specificity is desired.

The expert system can query the patient using a series of interactive and conditional questions depending on their previous medical problems or their new complaint. For example, if the patient complains of chest pain, the expert system can ask questions such as:

Do you have chest discomfort that only occurs with exertion or activity?

If “Yes,” then, when did you first experience this pain?

How frequently does it occur?

How long does it last?

When you have the pain, what makes it feel better?
Rubbing it
Deep breathing
Walking

What makes it feel worse?
Exercise
Sitting up
Lying down

The sequential questions can have sample answers provided and/or a “fill-in-the-blank” space for retrieving information that is not prompted by the system. Conventional sequential questioning by a physician can help establish a differential diagnosis but the conventional questioning is often truncated in the office due to time constraints. In addition, many patients do not like to be “interrogated” by their doctor. In many cases, it is easier to be interrogated by a computer that is perceived as being non-judgmental, such that more detail can be gleaned as compared to a face-to-face encounter with a person that scrutinizes the answers in front of them.

In operation 216, the system generates a history of events and patient complaints that is made available for the physician to review in narrative form. The generated history is usually made available to the physician even before the patient is seen by the physician. The system can also include notes and possible conclusions to the doctor as suggested by the expert system. The system can also include a physician's notes related to previous histories of the patient and/or notes from cases having similar diagnoses, for example. Accordingly, the history presented to the physician is more standardized (as compared with conventional methods), which allows the physicians to more quickly comprehend the material and to focus more on the patient.

In operation 218, a provider assistant such as receptionist or nurse can review the data with the patient and additionally add the patient's vital sign information (or other observations that can be automatically “trended” for comparison) for physician review and editing. Trending of information can include plotting of information related to patients' vital signs over time (for treatment or research purposes). For example, the assistant can review the referral forms (if any) to determine who sent the patient for the visit and why. The provider can review lists such as medications being taken by the patient, allergies, test results and correct any faulty data with the patient at the time of the interview.

In operation 220, data (including raw data from the above questioning) are entered in real-time directly into the Present and Past History section of the doctor's note for the present visit. The historical data is automatically coded from the patient's key entry session and placed into a relational database for future outcomes analysis.

In operation 222, the system generates a narrative history summarizing the patient-entered data for the physician, for example, to analyze. The summary typically includes the “where, when, how, and why” to provide a narrative report of the input data (e.g., “Mr. Miller relates a 3 year history of exertional chest pain occurring 3 times per week, lasting 10 minutes in duration, precipitated by exertion and relieved by rest”). The physician can review the data with the patient for accuracy and agreement on the content's validity. The physician can make corrections or embellish the report as desired, which are normally propagated through to the database as well. Because the questions are medical subspecialty-designed (for the expert system), the diagnosis is more likely to be apparent, with the history often providing 70 to 80% of the likelihood of a diagnosis.

In operation 224, the physician can use TEDS during the course of the actual physical examination. The system can provide a series of possible issues implicated by the physical examination such as which organ system is diseased (HEENT, lungs, heart, and the like). The system can thus prompt the physician with expert-level questions and considerations (such as warnings to the physician), which increase the quality of the care provided by the physician.

Narrative statements for each key word can be provided by the system and/or the physician can assign their own text to the key word and use that as a default for future encounters. The system is thus not limited to the preprogrammed responses of the knowledge base and can have the “look and feel” of custom notes. For example, if the physician selects “Rales” from other choices depicted in a pulmonary section of the physical examination, the system would prompt the physician to select/touch/click “Right,” “Left,” or “Both.” If the physician chooses “Right,” the system would then prompt for how much of the lung is affected, to which the physician can reply by selecting “⅓″ from a list comprising “½,” “⅓,” ¼,” and “⅕.”

For example, by making three clicks Rales-Right—⅓ the system can display, “Choice #1: Rales are noted in the lower ⅓ of the lung fields on the right.” The physician could thus retrospectively edit the narrative text and type in revisions. Optionally, the physician can provide a default statement such that the displayed system note would read: “At auscultation the city's best cardiologist heard right-sided rales involving the lower ⅓ of the lung field.” (As noted above, the default statement can be typed-in before a visit, and could also be designated during a visit to be used as the default for subsequent visits.) Any narrative text can be wrapped around (and/or otherwise associated with) a key word and displayed in response to the selected touch entry choices. Accordingly a note can be completed in real-time with hunt and peck typing techniques allowing markedly reduced typing requirements for the physician.

The system can offer a preformatted display of normal values for acceptance or revision by the physician. In one example, with one click the display can enter a complete normal physical exam that is unique to that physician's examination style, since the smart card knows who he/she is (Dr Smith) and what he/she does (Cardiologist) and their practice preferences. He/she can then highlight the small number of abnormalities noted in their usual examination. Abnormalities can be determined by comparing input data with predetermined threshold data such as values previously input by the physician, data bases containing distributions or data of healthy and unhealthy patients, and/or data from the patient's own last visit or hand entered by the doctor. Because the vast majority of internal medicine exams are “normal” or substantially unchanged from a last examination, display of normal and/or previous abnormalities can reduce the workload of the physician by confining the data input to the small number of abnormals compared to the much larger number of normals.

During the one-at-a-time touch, click or voice entry recording process, each data element can be counted, quantitated and categorized. For example, each field can be given a specific code number, similar to ICD9 diagnostic codes and/or the CPT procedure codes. Each element of history and each physical examination field is given a unique code number and entered into a relational database for future data analysis. These demographic, historical and physical co-variables can be used to define subpopulations and then target those that would be most likely to benefit, target away from those who will not benefit at all, leaving a remainder who might or might not benefit from the treatment. Targeted therapy can thus substantially reduce the cost of medical treatments and outlays of budgeted medical expenditures by 10 to 30% or more.

In operation 226, the details of the medical session are sent to a data storehouse for aggregation and further analysis. For example, narrative text associated with the selected choices (such as “Rales,” “Right,” and “⅓”) can be entered into a relational database for outcomes analysis and targeting. The outcome analysis can be increasingly applied to the whole population as more and more patients are entered from other delivery systems into the common database repository. The server can group the information without patient-identifying data into outcomes and share the information to physicians investigating related illnesses. For instance, it would be impossible to do a large study of Tay-Sachs disease because no institution has more than a few patients with this rare disease. But aggregating 3 to 20 from all of the medical centers would yield hundreds for patients and their therapy could be compared from one institution to another.

In addition, the gathered information can be used for billing purposes. As each touch entry is made, the system aggregates work units related to a patient (and/or payment entity) and use the data to generate a standardized bill. Because the bill can be generated during (or just after) the visit/treatment, the physician can verify the proper coding and billing while the encounter is still fresh in the physician's mind. The finished note can be presented to the physician in a form similar to the form in which a “coder” sees the form ex post facto, which also can substantially reduce errors and the physician's liability. Thus the system reduces the possibility that legitimate billable work would go unbilled, as well as to reduces the potential for inadvertent Medicare or insurance fraud.

As an example, the system can verify that the data is formatted using correct codes (e.g., Medicare and insurer codes, E&M codes, CPT codes, ICD9 codes, etc). The coding comprises, for example, location of service, timing of service, note type, key components of service, complexity of decision making, and a service checklist. The location of service codes can include whether the visit is Inpatient, Outpatient, or Observation. The timing of service can be “clocked in” from the time the patient's smart card is inserted and tracked as the card is used (other variables such as the timing of “tPA” (a treatment for acute stroke and heart attack victims) or angioplasty can be recorded). The note type can include such types as a consult note, “H&P” note, Office Note, ER visit note, letters, clearances, and the like. A service checklist can be generated in accordance with procedures normally performed when obtaining a patient's history, conducting a physical examination, doing a procedure and the like.

The system helps to standardize the medical record for the benefit of physicians, patients, and insurers. The system also analyses the aggregate data to determine the best medical and surgical practice outcomes using data collected on potentially millions of patients treated differently by thousands of physicians. The system provides the infrastructure to record all encounters and follow them over time and across delivery systems. Data mining from the variation in therapies across these databases provides the outcome analysis that identifies patients that would likely benefits from a particular therapy and those who would not.

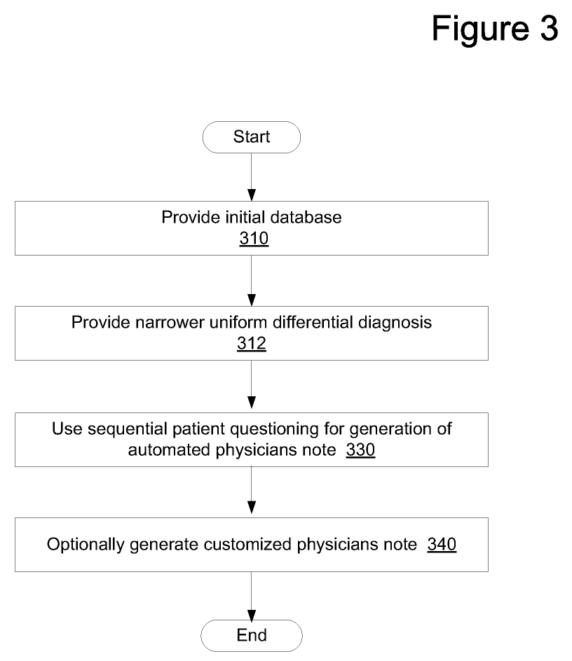

FIG. 3 is a flow diagram illustrating automation of the construction a medical record. For example, the medical record construction can automate data collection by using computer generated expert sequential questioning directly from the patient. The historical responses are directly stored in a relational database for data mining and outcome analysis. The physical findings from various physicians can be collected in a similar manner and entered directly into the database in a similar fashion.

In operation 310, an initial database structure is provided. For example, the initial database structure comprises a structure as illustrated in Table 1 below. The structure normally contains fields for symptoms, associated codes, and associated branches.

For example, symptoms such as cough, fever, chills, headache, chest pain, dizziness, and the like can be stored in a relational database to create a field structure that patients and physicians can use as a “pick list” for data entry. The collected co-variables can be used to determine a differential diagnosis, to risk stratify and/or to analyze outcomes from the various therapies physicians use to treat the symptoms such as cough, fever, dizziness, and the like. Moreover, the terms used by patients are often not specific enough and further questioning is normally done to sharpen these general complaints into more specific categories to define a more homogeneous “apples to apples’ population (in order to avoid the all to prevalent “apples and oranges” problem). For example:

As an example of the problem with terms, consider the common complaint of being dizzy. If a complaint of “feeling dizzy” was simply added to a database and that variable was used to determine the outcome of drug therapy for “dizziness,” the study would very likely not be successful in evaluating that drug. People complaining of dizziness comprise a heterogeneous population because the term is not precise enough to establish a specific etiology. The knowledge and ability of a physician to formulate a tighter differential diagnosis (“D×D”) varies significantly among physicians, so using a structured database can help sort the study group into more homogenous populations.

TABLE 1

| Symptom | Sx Code # | Branches |
|---|---|---|
| Cough | S2345.89 | 2 (productive, non-productive) |
| Fever | S1243.39 | 4 (Intermittent, Remittent, Persistent, other) |
| Chills | S1487.48 | 3 (Chills, Rigors, Feeling chilly/cold) |
| Dizziness | S1234.56 | 4 ([see example in operation 320 below]) |

In operation 320, intelligence is used to clarify semantic responses in the database to provide a narrower uniform differential diagnosis. For example, branching logic (such as IF-THEN responses and “case” statements) can be added to the database field structure. The sequential questioning allows sorting patients into more homogeneous classifications. For example, if the patient answers YES to the complaint of feeling “dizzy” the system recognizes (from the branching logic) that more detail is needed and it starts a prompting for a sequence of IF THEN responses. The computer recognizes that there are four initial branches to this tree (from Table 1, for example) and would prompt the patient to pick which response most correctly describes their feeling of dizziness:
1. Do you feel like you are spinning or that the room is spinning around you? (If “yes,” this is categorized as Vertigo, of which the most likely diagnosis is inner ear disease)
2. Do you stagger like someone who is drunk or do you feel like you are walking on a floating boat dock? (If “yes,” this is categorized as Ataxia, of which the most likely diagnosis is a neurological disease of the cerebellum or spinal cord.)
3. Do you feel lightheaded like you do when you stand up quickly on a hot day and the blood rushes away from your head toward your feet? (If “yes,” this is categorized as Lightheadedness, of which the most likely diagnoses are low blood pressure or side effects from medications.)
4. Does your vision blacken and your hearing get distant, like you could black out and lose consciousness but you don't actually pass out? (If “yes,” this is categorized as Pre-syncope, of which the most likely diagnosis is due to cardiovascular disease.)

Each of the four branches listed above leads to a more specific question. This process of sequential questioning identifies a more homogeneous population, helps formulate a differential diagnosis for further testing, and can be used to generate consult notes, progress notes, history and physicals examinations, creates a standardized billing system, and the like. If the patient complains of feeling “dizzy” and chooses “vertigo,” the system can ask additional questions (as in Table 2 below) to further refine the differential diagnosis and optimize the doctor's note.

TABLE 2

| | |
|---|---|
| When did you first notice this | Answer-2 months ago. |
| sensation of spinning? | |
| How often does it occur? | Answer-3 times a week. |
| How long does it last? | Answer-20 minutes. |
| What makes it better? | Answer-lying down with my eyes shut. |
| What makes it worse? | Answer-turning my head to the left. |

In operation 330, sequential questioning of the patient is used for generation of, for example, an automated physicians note. Key word data collected from the patient is used to generate a more sharply defined differential diagnosis and the ability of the physician to “wrap” narrative text around the key word is used to automate yet personalize the physician's note. The touch entry dictation system as described above uses a relatively small number of programmed sequential responses to generate notes tailored to more accurately describe patient story and fit the physician's narrative style.

The responses can be formatted by the user/physician to provide the answers in their desired format. For example, continuing on the same initial complaint of dizziness and the sequential questioning noted above, the automated note could read:
Mr. Smith relates a 2 month history of VERTIGO (key word) occurring 3 times per week, lasting 20 minutes in duration. The episodes are precipitated by turning his head to the left. They are made better by lying still with his eyes shut (Additional narrative text can be, for example, tailored a priori by each physician using the system or edited ex post facto).

In operation 340, sequential questioning of the patient is used for generation of a customized physicians note. The customized physicians note allows a note to have a semantic style of the physician that generates it. Using the example automated note listed above, the physician can add (such as entering text by typing) any text around a keyword, (for example, “VERTIGO”) such that the entered text can be used a template for customizing the physicians note. The system provides an underlying note for each key word selected. The physician can customize the text in a desired order and the next time the note will be generated with that chosen text and arrangement or they can edit the text, but not the key word, after the generic system note is generated. The system identifies each physician (when the physician uses the system with their smart card) and can retrieve the preferences of each physician when customizing notes. The generated template is retrieved using the keyword “VERTIGO” and fills in associated variables with data from the sequential questioning method and then placed in the context of the text supplied by the physician.

For example, a “Dr. Jones” can have his note customized from the above example automated note to read:
My patient Mr. Smith has experienced VERTIGO for the last 2 months. The episodes usually last for at least 20 minutes and occur on average 3 times per week. The episodes are most often triggered by turning his head to the left and he thinks they feel better if he lies down with his eyes shut.
   Automatically retrieving and generating a physician's note (and allowing customization of the note substantially reduces the likelihood that data related to the patient would be misunderstood, misrepresented, displayed, stored, or otherwise used incorrectly.

### Proposed Coding System.

In various embodiments, the ICD 9 coding system (when associated with the above key word sequential questioning TED system) can be augmented for more precise diagnostics. For example, the standard e-MR ICD 9 code for Premature Ventricular Contractions (PVCs) is 427.69. However, there are at least four types of PVCs, each of which reflects a different potential etiology and a different mortality risk: some are benign, while others can be very dangerous.

If a clinical trial were conducted where the outcomes of patients having PVCs were assessed without regard to the form of the PVCs (e.g., by using the conventional coding system as is), the true outcome of the trial could be significantly compromised. If for example, the outcomes of one group having 90% unifocal PVCs are combined (without regard to the form of PVC) with the outcomes of another group having 90% multiform PVCs, the study results would be questionable because the first group has a negligible mortality rate and the later has a significant mortality rate (which impeaches underlying assumptions of the clinical trial).

The disclosed system uses a proprietary sorting system that asks a series of questions for each diagnosis that could be better categorized in the ICD9 system. Additional letters or digits are appended to (or otherwise associated with) the ICD9 code to allow for categorizing a correct diagnosis to be used for outcome analysis. The standard ICD9 code can still be used for billing purposes by, for example, truncating the characters (used for precise diagnoses) concatenated to the ICD9 code.

To continue with the example of more accurate coding for PVC diagnoses, the code PVC 427.69 is selected for a PVC diagnosis. To further classify the diagnosis, the system would ask:

Q1 Are the morphologies the same or different? YES NO

Q2 are the coupling intervals the same are different? YES NO to which the physician can supply the appropriate answers.

In response to the supplied answers, the system can provide an extended code such as given in Table 3:

TABLE 3
ICD9 code revision for PVC 427.69

| Symptom: | | | Diagnostic Code Keys: |
|---|---|---|---|
| Morphology | same | Interval same | Unifocal PVCs 427.691 |
| Morphology | same | Interval different | Parasystole PVCs 427.692 |
| Morphology | different | Interval same | Multiform PVCs 427.693 |
| Morphology | different | Interval different | Multifocal PVCs 427.694 |

Accordingly, the disclosed system codes for (at least) four classes of PVCs (the classes can be modified or added to when the medical science progresses). Thus, the causes of the PVCs can be more accurately accessed and the risk of death from the PVCs can be better predicted. For example, multiform PVCs are rare and are most often associated with digitalis toxicity. They can be fatal if untreated: the disclosed system asks the additional questions to allow the attending physician to recognize a specific cause and treat for that specific cause. As discussed above, the system can be asked to use the standard classification portion (e.g., 427.69) of the accepted ICD9 code and use the augmented code (e.g., 427.691) for outcome analysis and strip the trailing digits so that existing billing codes need not be altered.

Although the invention has been described herein by way of exemplary embodiments, variations in the structures and methods described herein may be made without departing from the spirit and scope of the invention. For example, various input devices and components can be used to enter and retrieve data from the system. Such components and arrangements of components can be implemented using computers, PDAs, smart phones, memory sticks, radiofrequency imbedded chips, and the like. Since many embodiments of the invention can be made without departing from the spirit and scope of the invention, the invention is not limited except as by the appended claims.

What is claimed is:

1. A point-of-service information system, comprising:
a client that is configured to access a consumer computer-readable storage device that is associated with a consumer for storing consumer information that comprises information from a consumer history and to retrieve authentication credentials associated with the computer-readable storage device;
a server that is configured to authenticate the client using the received authentication credentials and a password/biometric identification from the consumer, to access the consumer history from the consumer computer-readable media device in response to successful authentication, to prepare a report of the consumer history for a provider of services, and to direct the client to store a portion of the report on the computer-readable storage device.

2. The apparatus of claim 1, wherein the server comprises a knowledge-based system for prompting the consumer to answer questions related to the consumer history.

3. The apparatus of claim 2 wherein the server receives answers from the consumer in response to the prompted questions, then processes the answers in accordance with the knowledge-based system to record a standardized medical record. determine a possible diagnosis, and include the possible diagnosis in the report of the consumer history.

4. The apparatus of claim 3, wherein the client displays the consumer history to the provider.

5. The apparatus of claim 4, wherein the client displays questions to be answered by the provider, receives answers from the provider, wherein the questions to be answered by the provider are generated using the knowledge-based system and received answers from the provider in real-time.

6. The apparatus of claim 1, wherein the server comprises a knowledge-based system for prompting the provider to answer questions related to the health of the consumer.

7. The apparatus of claim 6, wherein the server processes the answers from the provider in accordance with the knowledge-based system to provide a summary of the answered questions, to determine a possible diagnosis, and to display the summary and diagnosis to the provider.

8. The apparatus of claim 7, wherein the client is configured to permit the provider to edit the displayed summary and/or diagnosis.

9. The apparatus of claim 8, wherein the server is configured to store the edited summary and to display the edited summary at a subsequent authenticated session in which the same answers are given by the provider.

10. The apparatus of claim 9, wherein the server is configured to automatically generate information for billing for services provided to the consumer in response to answers from the provider in accordance with the knowledge-based system.

11. The apparatus of claim 1, wherein the client comprises a touch-sensitive screen for displaying questions and receiving an answer for each question using a single touch or mouse click.

12. The apparatus of claim 1, wherein the server retrieves an appointment date record associated with the consumer to determine whether the consumer has an appointment.

13. The apparatus of claim 12, wherein the server further determines the kind of appointment.

14. A method for providing diagnostic services, comprising:
receiving answers received from a consumer of diagnostic services; wherein the received answers are in response to predetermined questions displayed by a knowledge base system, and wherein at least one of the predetermined questions is displayed in response to the received answers;
displaying a template to a diagnostic service provider for displaying the received answers, wherein the template is customized by the diagnostic service provider to provide a desired format that is determined by text provided by the diagnostic service provider and a variable entry for displaying a received answer; and
generating and storing a summary of the received answers in response to the customized template, wherein the summary is organized in the desired format.

15. The method of claim 14, further comprising displaying the received answers to the diagnostic service provider, customized using a default template.

16. The method of claim 15, wherein the diagnostic service provider customizes the template in response to the default template.

17. The method of claim 14, wherein the diagnostic service provider customizes the template in response to the default template.

18. A system for providing diagnostic services, comprising:
means for prompting a consumer to provide a consumer history;
means for using a knowledge-based system to generated consumer questions in response to the provided consumer history;
means for receiving answers from the consumer in response to the generated consumer questions;
means for preparing a consumer answer summary of the received consumer answers;
means for using the knowledge-based system to generate provider questions in response to the provided consumer history and/or the consumer answer summary;
means for displaying the provider questions to the provider;
means for receiving answers from the provider in response to the generated consumer questions; and
means for generating and storing a provider summary in response to the received provider answers and consumer answer summary.

19. The method of claim 18, further comprising means for generating billing in response to the received provider answers.

20. The method of claim 18, further comprising means for linking the consumer history to a biometric identifier and using the biometric identifier to establish a secure session.

21. A method for adjudicating remote services, comprising:
receiving a computer-readable storage device that is associated with a consumer;
authenticating a consumer-entered password and/or biometric identifier using information from the computer-readable storage device;
granting access to a secure area on the computer-readable storage device that comprises a locator for a provider of remote services;
using the locator to access a provider of remote services; and
storing information on the computer-readable storage device that is downloaded from the provider of remote services.

22. The method of claim 21, wherein the computer-readable storage device is issued by the provider of remote services.

23. The method of claim 21, wherein the access is granted in accordance with credentials supplied by a local provider of services.

24. The method of claim 23, wherein the access is granted to different secure areas in accordance with the credentials supplied by a local provider of services.

25. The method of claim 21, wherein the locator is a URL that provides a link to an insurance provider server for determining date-sensitive insurance coverage of the consumer.
